(19) United States
(12) Patent Application Publication
(10) Pub. No.: US 2014/0034771 A1
(43) Pub. Date: Feb. 6, 2014

(54) TARP DEPOLYING APPARATUS AND METHOD FOR UNEVEN LOADS ON FLAT BED

(71) Applicants: Michael Dean Hecker, Silver City, IA (US); Mark Anthony Corso, Edwardsville, IL (US); Scott Leroy Messamaker, ndianola, IA (US)

(72) Inventors: Michael Dean Hecker, Silver City, IA (US); Mark Anthony Corso, Edwardsville, IL (US); Scott Leroy Messamaker, ndianola, IA (US)

(73) Assignee: ROBERTS & DYBDAHL, INC., West Des Moines, IA (US)

(21) Appl. No.: 13/563,260

(22) Filed: Jul. 31, 2012

(51) Int. Cl. B60P 7/04; B65H 75/42; B65H 75/44; B65H 16/04

(52) U.S. Cl. 242/395; 242/398; 242/402; 242/396; 242/396.5; 242/389

(57) ABSTRACT

A tarp deploying apparatus includes a frame assembly that is adapted for being attached to a lifting device, such as a forklift. A roller assembly extends laterally from the frame assembly. A tarp may be loaded onto the roller assembly by rolling the tarp onto a roller body. The tarp may be deployed in a desired position on a load of cargo on a flatbed trailer. The tarp is deployed on the cargo by driving the forklift alongside of the flatbed trailer and allowing the tarp to unroll off the roller body being pulled off the roller body by the weight and friction of the tarp on the load. The roller body may include hooks that help in loading the tarp onto the roller body, and allow the tarp to automatically fall off of the roller body during deployment.

### FIELD OF THE INVENTION

The present invention relates to a method and apparatus for positioning a tarpaulin over a load on a flatbed trailer to protect and secure the load.

### BACKGROUND OF THE INVENTION

Flatbed trailers are commonly used to transport cargo, such as lumber, other construction materials, manufactured components, containers, boxes, and other freight. In order to protect the cargo while it is loaded on the flatbed, it is common to cover the load with a tarpaulin, also referred to herein as a tarp. The tarp serves to protect the cargo from environmental elements, such as dirt, precipitation, sunlight, and wind. Additionally, the tarp serves to secure the cargo on the flatbed such that it will not blow away, and such that it is not easily stolen off the trailer when the trailer is parked.

Positioning the tarp onto the cargo can be a cumbersome job. The difficultly of the job can be exacerbated when the cargo results in an uneven load of varying heights. The most common method for positioning a tarp on such an uneven load is to have one or more workers climb on top of the load and position the tarp as they unfold it across the load. However, due to the height of the load above the ground, and the potentially unstable and uneven surface on top of the cargo load, this can be dangerous. It is also known to build elevated structures such as a u-shaped walkway or dock that a flatbed trailer can be positioned adjacent to in order to permit workers to position a tarp on top of a loaded flatbed trailer without climbing onto the load itself. These structures have the disadvantage of representing a fairly significant initial capital expense, as well as being stationary structures that occupy significant space.

U.S. Pat. No. 7,314,244 describes a method and apparatus for positioning a tarp over cargo on a flatbed using a lifting device, such as a forklift, with a flat frame extending laterally from the forklift. In use, a worker completely unfolds a tarp and positions it on the flat frame. The flat frame is then elevated by the forklift above the load, and as the forklift is driven longitudinally along the side of the loaded flatbed, the unfolded tarp is pulled off the flat frame and positioned on the load. This represents an improvement over the manual methods described above, but is cumbersome and inefficient in requiring the tarp to be unfolded by a worker prior to being positioned on the load.

Thus, there is a need for an apparatus and method for positioning a tarp on cargo loaded on a flatbed. Preferably, the method and apparatus should avoid the need for a worker to climb on top of the load in order to position the tarp. Furthermore, it would be desirable to avoid the need for permanent elevated structures that consume significant amounts of space, such as elevated loading docks. Preferably, the method and apparatus will not require a worker to completely, or nearly completely, unfold the tarp prior to positioning the tarp on top of the load.

### BRIEF SUMMARY OF THE INVENTION

According to one embodiment, the present invention is a tarp deploying apparatus that includes a frame assembly with attachment structure for connecting the frame assembly to a lifting device. A roller assembly extends generally laterally from the frame assembly. The roller assembly includes a roller body adapted to have a tarp rolled upon it. The roller body may have a plurality of hooks on it for engagement with openings in a tarp. Each of the hooks may be shaped such that when the roller body is oriented such that a distal end of the hooks extend generally upwardly, the hooks will retain a free end of the tarp such that it can be rolled on to the roller body by rotating the roller body in a first direction. Each of the hooks may be shaped such that when the roller body is oriented such that the distal ends of the hooks extend generally downwardly, the hooks will permit the tarp to fall off of the hooks as the roller body rotates in a second direction opposite from the first direction. The roller assembly may include a spindle that is cantilever mounted to the frame assembly with the roller body mounted to the spindle for rotation about the spindle. The roller assembly may also include a handle operably connected to the roller body whereby rotation of the handle causes corresponding rotation of the roller body. The tarp deploying apparatus may include a brake member that resists rotation of the roller body. The brake member may be a resilient flap mounted to the frame assembly. The roller assembly may include a handle operably connected to the roller body for rotation with the roller body, the handle including a plurality of spokes. The resilient flap may extend from the frame assembly towards the handle such that a free end of the flap is in alignment with the plurality of spokes whereby rotation of the roller body causes the spokes to periodically contact the free end of the flap when the roller body rotates. A counterbalance weight may be provided on the frame assembly.

According to another embodiment, the present invention is directed to a method of deploying a tarp onto cargo loaded on a flatbed trailer. A tarp deploying apparatus that has a frame assembly and a roller assembly including a roller body with a tarp rolled upon it is attached to a forklift. The forklift is positioned at a first end of the flatbed trailer with the roller body positioned generally above an upper surface of the cargo. A portion of the tarp is partially unrolled off of the roller body such that a first portion of the tarp is in contact with the cargo or the flatbed trailer. The forklift is moved alongside the flatbed trailer toward a second end of the flatbed trailer with the roller body raised above the upper surface of the cargo whereby resistance caused by the first portion of the tarp in contact with the cargo or the flatbed trailer causes the tarp to unroll off of the roller body onto the cargo. A tarp maybe rolled on to the roller by engaging eyelets on the tarp to a plurality of hooks the roller body and rotating a handle operably connected to the roller body. The forklift may be moved along the flatbed trailer until the tarp falls off of the hooks. The roller body may be maintained at a desired distance above the upper surface of the cargo by raising and lowering the roller body as the forklift is moving alongside the flatbed trailer.

A handle may be provided in operable connection to the roller body for rotation with the roller body. A resilient flap may extend from the frame assembly towards the handle such that rotation of the roller is resisted by the handle periodically contacting the resilient flap.

According to yet another embodiment, the present invention is directed to a tarp deploying apparatus that includes a frame assembly with a top plate having an upper surface and a lower surface, the top plate further having first and second lateral edges spaced apart from and generally parallel to each other. Attachment structures adapted for receiving tines from a forklift are provided on the lower surface. A support structure supports the top plate above ground level. A spindle is mount to the top surface and extends laterally beyond the first lateral edge of the top surface. A roller body is mounted to the spindle for free rotation about the spindle. A plurality of hooks in alignment with each other is provided along the roller body. A handle structure is operably connected to the roller body for rotation with the roller body. The spindle may be an elongated shaft. The roller body may be a cylindrical tube, and at least one set of ball bearings may be provided between the spindle and the roller body. A brake for slowing rotation of the roller body around the spindle may include a resilient flap that periodically contacts the handle as the roller body rotates around the spindle. A counterbalance weight may be provided on the frame assembly near the second lateral edge of the top plate.

### BRIEF DESCRIPTION OF THE DRAWINGS

FIG. 1A is a front elevation view of a tarp deploying apparatus according to one embodiment of the present invention.

FIG. 1B is the tarp deploying apparatus of FIG. 1A with a portion of the roller tube cut away to show the spindle and bearings on which the roller is mounted.

FIG. 2 is a top plan view of the tarp deploying apparatus of FIG. 1A.

FIG. 3 is an isometric view of the tarp deploying apparatus of FIG. 1A with a tarp positioned for being rolled onto the roller of the tarp deploying apparatus.

FIG. 4A is a side elevation view of a flatbed trailer with an uneven load wherein a tarp deploying apparatus according to the present invention is positioned at a first end of the load at the beginning of the process of positioning the tarp on the load.

FIG. 4B is a top plan view of the loaded flatbed trailer and tarp deploying apparatus of FIG. 4A.

FIG. 5A is a side elevation view of the loaded flatbed trailer and tarp deploying apparatus of FIG. 4A, wherein the tarp has been positioned on about half of the load.

FIG. 5B is a top plan view of the loaded flatbed trailer and tarp deploying apparatus of FIG. 5A.

FIG. 6 is a close up detail view of a portion of the tarp deploying apparatus of FIG. 3.

FIG. 7 is a front elevation view of another embodiment of a tarp deploying apparatus according to the present invention, wherein the roller is supported from the frame by a tower and wire structure.

FIG. 8 is a cross-section view of the roller body from FIG. 1A, with a tarp releasing position indicated in broken lines.

### DETAILED DESCRIPTION OF THE PREFERRED EMBODIMENTS

The attached drawings show a preferred embodiment of a new apparatus and method for positioning a tarp on a loaded flatbed trailer. As can be seen in the drawings and the following description, the apparatus includes a frame that is suitable to be attached to a lifting device, such as a forklift. A roller extends laterally from the frame. The roller is suitable to have a folded tarp rolled around and carried on the roller. In order to position the tarp on the loaded flatbed trailer, the forklift is driven longitudinally along the side of the loaded flatbed trailer with the forklift used to raise and lower the roller so that it is positioned a small distance above the load. As the forklift drives along the side of the flatbed trailer, the tarp unrolls off the roller into position on top of the load. Therefore, there is no need for substantial permanent structure, for any users to climb on top of a load, or for a user to completely unfold the tarp prior to positioning the tarp on the load.

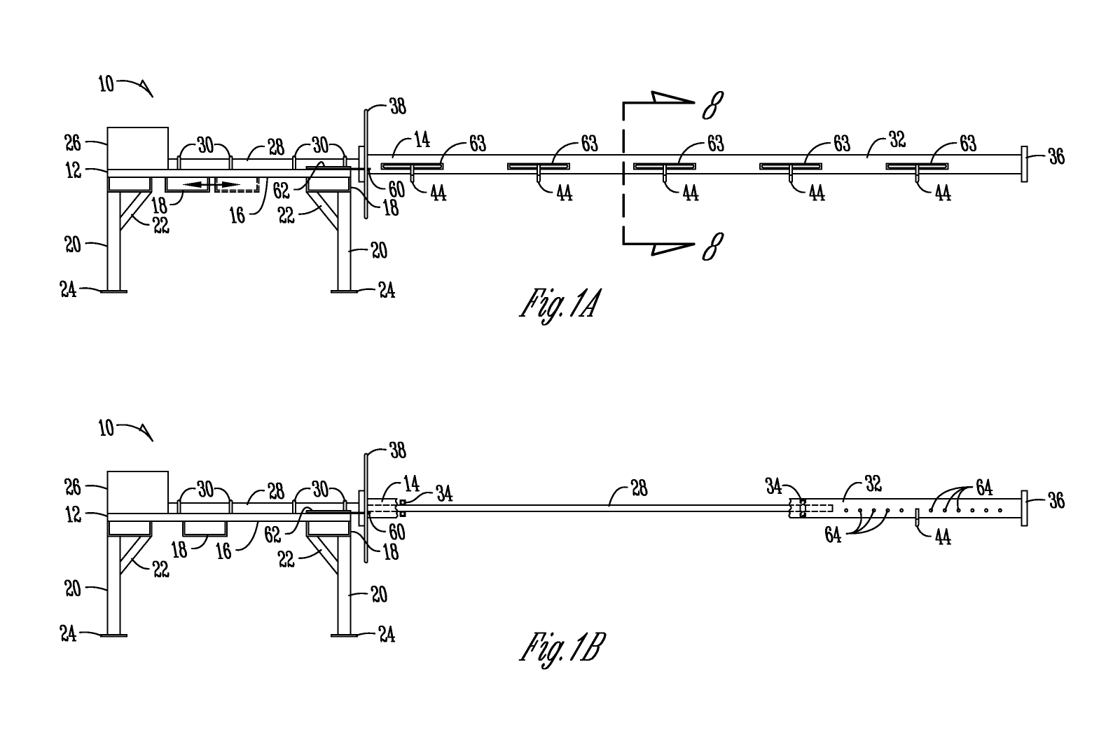

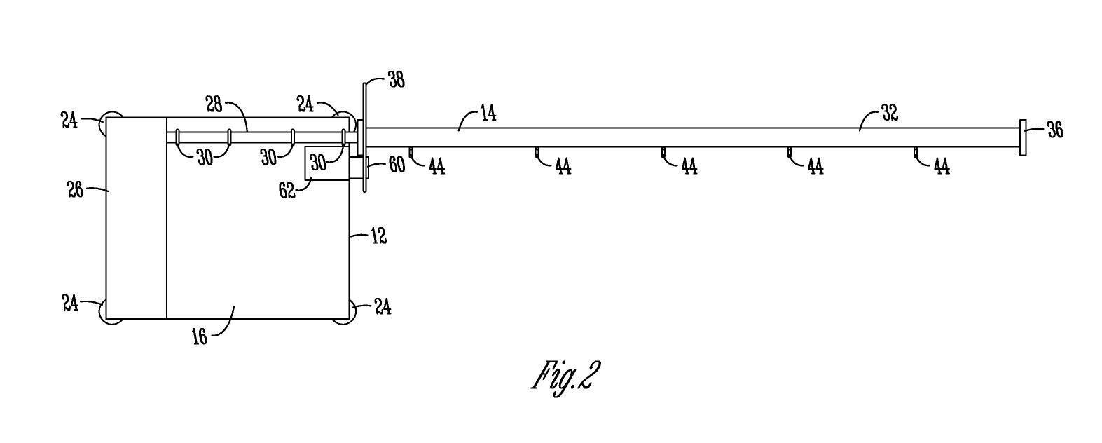

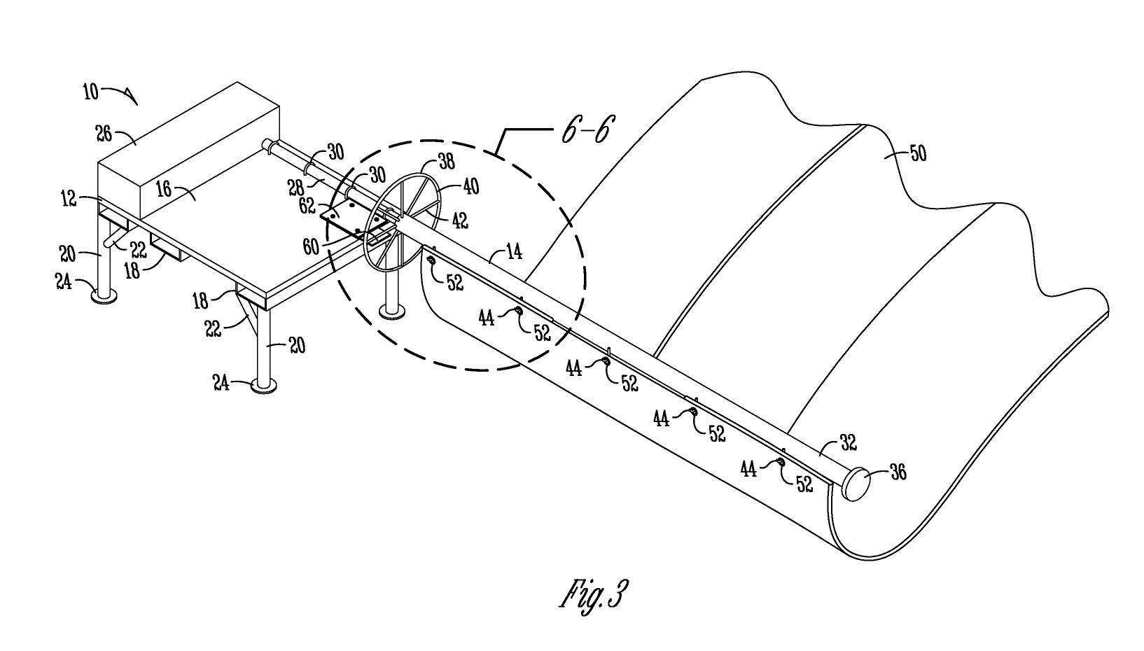

Turning in detail to the figures, FIG. 1A shows a tarp deploying apparatus 10 according to one embodiment of the present invention. The tarp deploying apparatus 10 includes a frame assembly 12 that supports a roller assembly 14. The frame assembly 12 includes a mounting structure such as top plate 16. The top plate 16 provides a structure on which the roller assembly 14 can be mounted to the frame assembly 12.

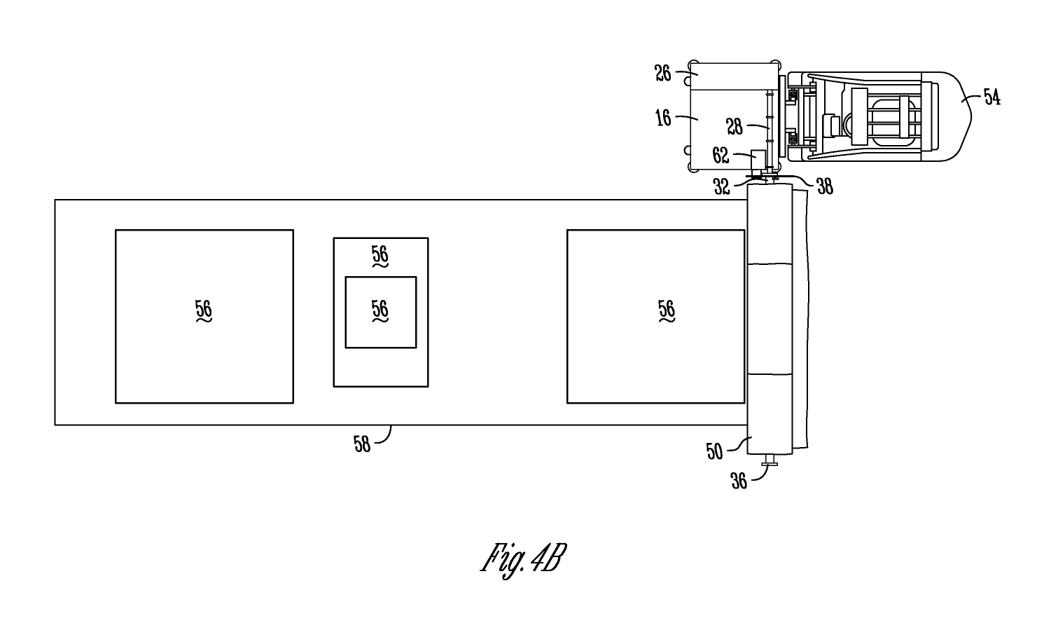

The frame assembly 12 may be a pallet or skid that is modified to include the features described herein. The frame assembly 12 includes attachment apparatus in order to permit the frame assembly 12 to be attached to a lifting device, such as a forklift (not shown in FIG. 1A, see FIG. 4A). In the embodiment of FIG. 1A, the attachment apparatus takes the form of rectangular sleeves 18. The attachment sleeves 18 may be brackets or the like attached to the bottom surface of the top plate 16. The attachment sleeves 18 provide passageways or pockets into which the forks of a forklift can be inserted in order to attach the frame assembly 12 to the forklift. Accordingly, the attachment sleeves 18 should be spaced apart such that their spacing matches the space between the tines on the forklift, or other lifting device, that will be used with the tarp deploying apparatus 10. The attachment sleeves 18 may also serve to reinforce and stiffen the top plate 16. Optionally, the attachment sleeves 18 may be adjustable, as shown in broken lines in FIG. 1A so that forks of varying widths can be accommodated.

The frame assembly 12 also includes legs 20 that are useful for positioning the mounting structure, such as the top plate 16 at a desired height above the ground. Preferably, the legs 20 will be of sufficient height such that the roller assembly 14 has sufficient ground clearance when a full tarp is completely wound around the roller assembly 14. Additionally, elevating the roller assembly 14 makes the tarp deploying apparatus 10 more ergonomic by positioning the roller assembly 14 at a convenient height for rolling the tarp onto the roller. The legs 20 may be supported by angular braces 22 in order to improve structural integrity and provide desired stiffness for the frame assembly 12 as a whole. Furthermore, the legs 20 may be provided with feet 24 to better distribute the weight of the tarp deploying apparatus 10 and provide better stability.

A counterbalance weight 26 may be provided on the frame assembly 12 at an opposite side of the frame assembly 12 from the roller assembly 14. The counterbalance weight 26 helps to maintain the center of mass of the entire tarp deploying apparatus 10 at or between the attachment sleeves 18, even when a full tarp is provided on the roller assembly 14. This can be important to prevent a significant twisting or tipping moment from being applied to the tarp deploying apparatus 10, and thereby to the forklift, when in use with a tarp on the tarp roller 14. The counterbalance weight 26 may be any suitable structure that sufficiently counterbalances the weight of the roller assembly 14 and tarp.

For example, the counterbalance weight 26 might be lengths of I-beam, concrete ballast, cinder blocks, or other similar items.

The roller assembly 14 includes a spindle 28 fixed to the top plate 16. In the embodiment shown, the spindle 28 is welded to the top plate 16. Additionally, the spindle 28 is secured to the top plate 16 by u-shaped brackets 30. The u-shaped brackets 30 are threaded on each leg, and extend through the top plate 16. The u-shaped brackets 30 are held in place by nuts and washers (not shown). The nuts and washers may be welded in place to provide a secure connection. Those of skill in the art will be aware of numerous mechanisms for fixing the spindle 28 to the top plate 16 in a satisfactory manner. According to one embodiment, the spindle 28 is a solid shaft having an outer diameter of about two inches. According to the embodiment shown, the spindle 28 is about twelve feet in length. The spindle 28 is cantilever mounted to the frame assembly 12, such that about eight feet of the spindle 28 extends laterally beyond the edge of the top plate 16 to which it is mounted. Those of skill in the art will be able to determine other suitable dimensions and materials for the spindle 28. For example, the spindle 28 might appropriately be formed from a hollow pipe, rather than a solid shaft, if appropriate materials and dimensions are selected.

A roller body 32 is journaled around the free end of the spindle 28. The roller body 32 extends laterally a distance farther than the spindle 28. In the embodiment shown, the roller body 32 extends about an additional four feet beyond the end of the spindle 28. The roller body 32 is mounted for free rotation about the spindle 28. The roller body 32 may be a hollow cylinder formed from a hard durable material, such as a suitable metal. As seen in FIG. 1B, wherein a portion of the roller body 32 has been cut away, the roller body 32 is supported on the spindle 28 by bearings 34. The bearings 34 may be ball bearings that are preferably low friction in order to permit easy rotation of the roller body 32 around the spindle 28. In the embodiment shown, two sets of bearings 34 have been used. A first set of bearings 34 is provided proximate to the frame assembly 12, and a second set of bearings 32 is provided near the free end of the spindle 28. According to the embodiment shown, the roller body 30 has an outer diameter of about 4 ½ inches, and an inner diameter of about 2 ½ inches. The exact dimensions of the various components are not critical, and those of skill in the art will be able to select appropriate materials and sizes to meet their needs.

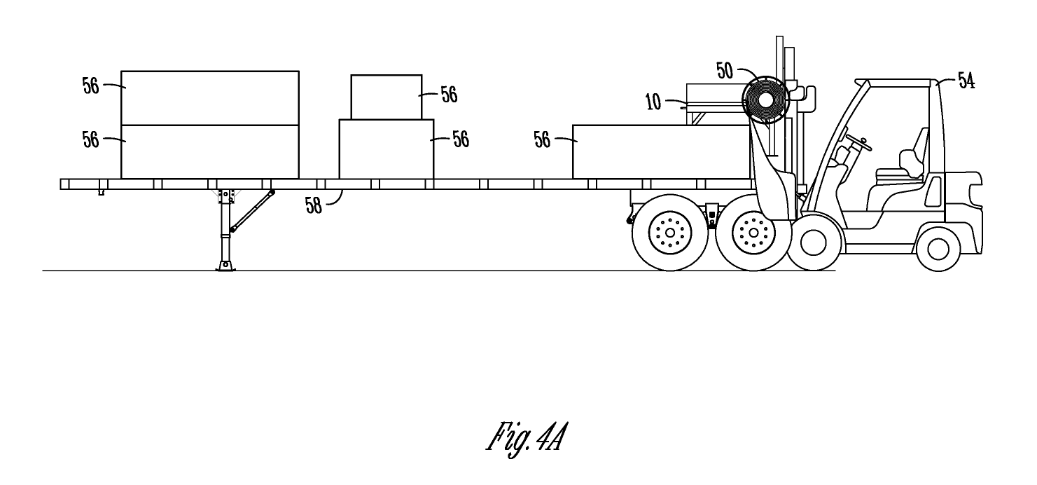

The roller body 32 is provided with an end cap 36 that prevents dirt, water, and other impediments from getting into the roller body 32 and impeding the free rolling of the roller body 32 around the spindle 28. A handle in the form of wheel 38 is provided on the roller body 32 near to the frame 12. The wheel 38 allows a user to rotate the roller body 32 around the spindle 28 by grasping the wheel and turning it in either direction. The wheel 38 serves to provide an easy and convenient element for a user to grab, and provides a mechanical advantage to make rotation of the roller body 32 easy to accomplish. In the embodiment shown, the wheel 38 has an outer diameter of about 2 feet. As best seen in FIG. 3, the wheel 38 includes a circular outer hoop 40 and inner spokes 42. As an alternative to the wheel structure, the handle could be formed without the outer loop 40, such that the spokes 42 act as individual handles. As a further alternative, the handle could be formed from a solid disc.

The tarp deploying apparatus 10 may also be provided with a braking or slowing apparatus so that as the tarp is being deployed, the momentum of the spinning roller body 32 with the tarp rolled upon it does not continue to spin, or unroll too fast during deployment. In particular, a resilient brake flap 60 is provided that extends from the top plate 16 towards the wheel 38. The brake flap 60 is secured to the top plate 16 by a securement plate 62. The brake flap 60 extends far enough beyond the edge of the top plate 16, such that it interferes with the spokes 42 of the wheel 38, as the wheel rotates. The brake flap 60 should have enough stiffness to provide resistance to rotation of the wheel 38, but should be flexible enough to permit the spokes 42 to move the flap 60 out of the way such that the wheel 38 can continue to rotate. In the embodiment shown, the brake flap 60 is formed from a sheet of plastic. The securement plate 62 is a thin metal plate that is secured to the top plate 16 via threated fasteners. Preferably, the threaded fasteners will also pass through and lock the brake flap 60 in place. The brake flap 60 may wear, or lose resilience over time and through use of the apparatus 10. If that occurs, the brake flap 60 may be replaced by unscrewing the threaded fasteners, removing the securement plate 62, removing the old brake flap 60, and inserting a new brake flap 60.

A series of hooks 44 are provided on the roller body 32. The hooks 44 should be in alignment with each other along the length of the roller body 32. The hooks 44 should be spaced apart to match the spacing of eyelets 52 provided on a standard tarp 50. Typically, the hooks 44 will be provided about 18 inches to 2 feet from each other. As best seen in FIG. 8, each of the hooks 44 includes a body portion 46 that extends generally outwardly from the outer surface of the roller body 32. Each of the hooks 42 also includes at its distal end a tarp retaining portion 48 that extends somewhat transversely from the body portion 46. The tarp retaining portion 48 serves to help retain the tarp on the hook 44 when the hook 44 is received within the eyelet, and the roller body 32 is rotated to a position such that the tarp retaining portion 48 is pointed in a generally upward direction, as shown in solid lines in FIG. 8. When the roller body 32 is rotated such that the tarp retaining portion 48 is pointed generally downwardly, as shown in broken lines in FIG. 8, the eyelet 52 will freely slide off of the hook 44. As will be described in greater detail below, this is advantageous because it permits the hooks 44 to be used to help load the tarp 50 onto the roller body 32, but also permits the tarp 50 to freely drop off of the roller body 32 after it is completely deployed onto the load, without the need for a user to manually release the tarp 50 from the roller body 32. In FIG. 8, the hook 44 shown in solid lines is in a position such that it can begin the process of loading the tarp onto the roller body 32.

The hook 44 shown in broken lines is rotated into a position where it will freely release the tarp 50 to automatically drop off of the roller body 32.

The hooks 44 may be attached to the roller body 32 in a variety of fashions. In the embodiment shown, each of the hooks 44 include a threaded portion (not shown), that is received within a threaded hole 64. Several threaded holes 64 are provided along the length of the roller body 32, such that the locations of the hooks 44 can be adjusted to match tarps having eyelets in varying locations. Other mechanisms that permit adjustment of the location of the hooks may also be used, such as elongated slots, hook and loop fasteners (e.g., Velcro), or other known mechanisms. Alternatively, the hooks 44 may be welded in place spaced apart at a common distance for eyelets.

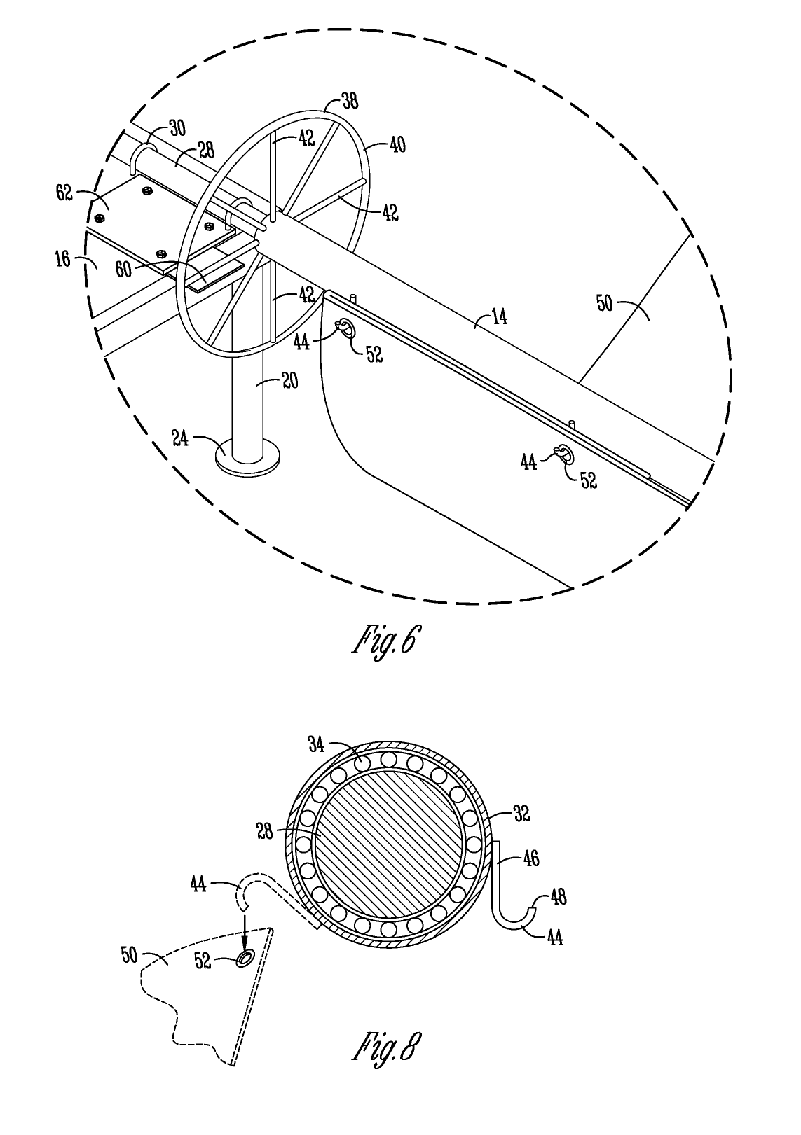

FIGS. 3 and 6 show a tarp 50 that has been partially unfolded, and is positioned with its eyelets 52 placed into engagement around hooks 44, such that it is ready to be loaded onto the roller body 32. In order to load the tarp 50 onto the roller body 32 from the arrangement shown in FIG. 3, the user would rotate wheel 38, causing the roller body 32 to correspondingly rotate around the spindle 28. As the roller body 32 rotates about the spindle 28, the hooks 44 will pull on the tarp 50 through the eyelets 52, causing the tarp 50 to wrap around the roller body 32, and then around upon itself. The user will continue to rotate the wheel 38 until the entire tarp 50 is rolled around itself on the roller body 32. With the entire tarp 50 rolled upon the roller body 32, the tarp deploying apparatus 10 is in a configuration where it is ready to be used to deploy the tarps 50 in position on a load provided on a flatbed trailer.

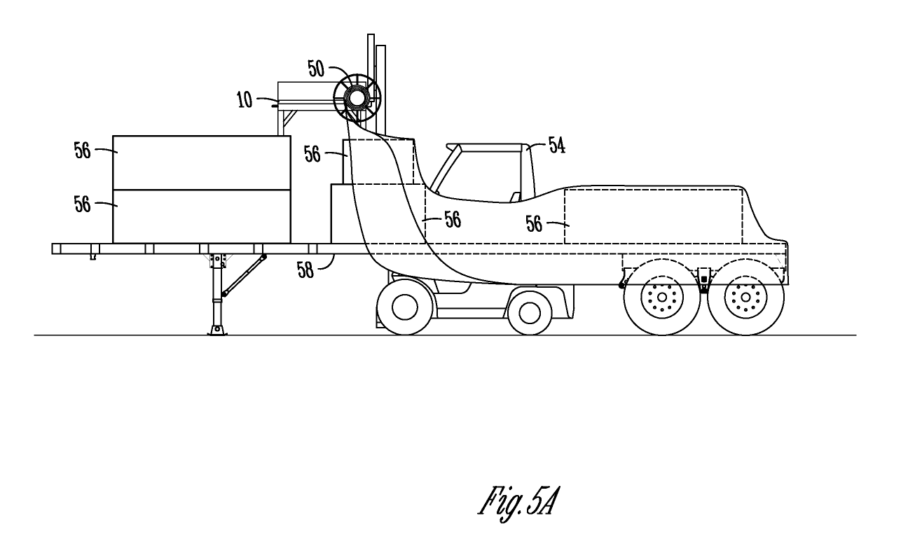

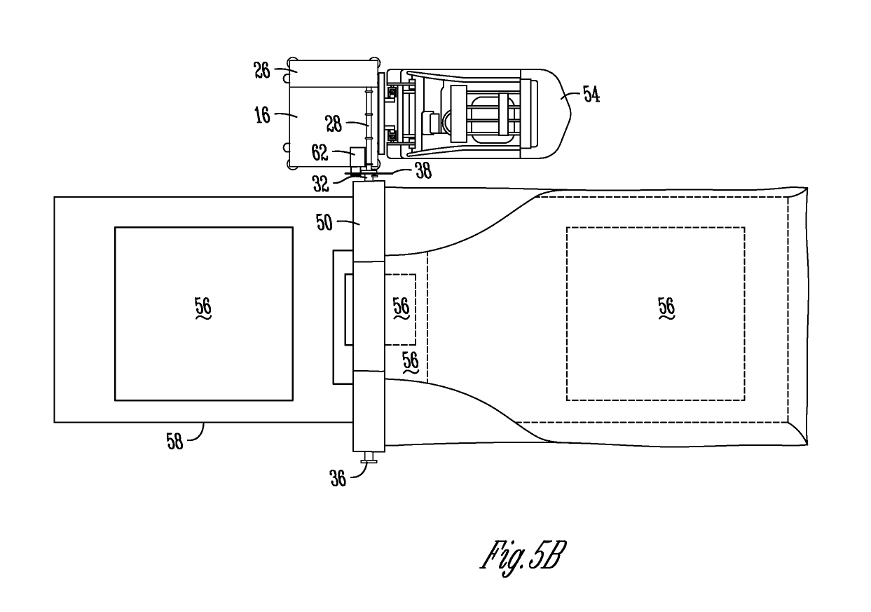

FIGS. 4A and 4B show the tarp deploying apparatus 10 attached to a lifting device in the form of forklift 54. The forklift 54 is positioned such that it is just beginning to deploy the tarp 50 onto cargo 56 that has been loaded onto a flatbed trailer 58. As can be seen in FIGS. 4A and 4B, the forklift 54 is positioned near the rear of the flatbed trailer 58, and alongside the longitudinal length of the flatbed trailer 58. It would also be acceptable to deploy the tarp from the front of the trailer towards the rear of the trailer 58, if desired. While not visible in FIGS. 4A and 4B, it should be appreciated that the forks of the forklift 54 have been inserted into the attachment sleeves 18 of the tarp deploying apparatus 10 in order to attach the tarp deploying apparatus 10 to the forklift 54. Additionally, while not shown, it may be desirable to include a safety chain or other attachment mechanism between the top deploying apparatus 10 and the forklift 54 to assure that the tarp deploying apparatus 10 does not fall off of the forklift 54, which could damage the tarp deploying apparatus 10, and worse still, could be dangerous to users or other people in the area. The rear flap of the tarp 50 may be left loose and unrolled upon the roller body 32 prior to use. Alternatively, the end portion of the tarp 50 may be pulled by hand so that it is partially unrolled off of the role into the configuration shown in FIG. 4A. From this position, the tarp 50 may be secured to the rear portion of the flatbed trailer 58 prior to deploying the tarp 50; however, it is not necessary to do so prior to deploying the tarp 50. To begin deploying the tarp onto the cargo 56 from the position shown in FIG. 4A, a user will raise the tarp deploying apparatus 10 using the forklift 54 such that the roller body 32 is a small distance above the top surface of the first portion of the cargo 56. With the roller body 32 slightly above that portion of the cargo 56, the forklift 54 can be driven forward along the side of the flatbed trailer 58. As the forklift 54 moves forward longitudinally along the flatbed trailer 58, the weight of the tarp 50, as well as the friction of the tarp resting against the cargo 56 (or if secured, the attachment of the tarp 50 to the flatbed trailer 58), will cause the tarp 50 to pull against the tarp rolled up on the roller body 32, which will in turn cause the roller body 32 to rotate about spindle 28, and in turn cause the tarp 50 to feed off of the roll around roller body 32 and onto the top of cargo 56. As the forklift 54 is driven alongside the flatbed trailer 58, the height of the roller body 32 can be adjusted to be maintained at roughly a constant space above the top of the cargo 56 onto which it is deploying the tarp 50 by raising and lowering the forks of the forklift 54. In this fashion, the tarp 50 can be distributed evenly across the load without gathering and bunching upon itself. The raising and lowering of the level of the roller body 32 is best seen in FIG. 5A, which shows the forklift 54 advanced to about ⅔ of the way down the length of the flatbed trailer 58.

As the forklift continues to move along the side of the flatbed trailer 58, the tarp 50 continues to unroll off of the roller body 32 to be deployed upon the top of the cargo 56. The person driving the forklift will continue to move the forklift 54 until the roller body 32 is beyond the cargo 56. Eventually, the tarp 50 will be completely unrolled off of the roller body 32. As described above with respect to FIG. 8, the eyelets 52 of the tarp 50 will slide off of the hooks 44 automatically to complete the deployment of the tarp 50. At that point, the tarp 50 should be completely deployed on top of and covering the load of cargo 56 on the flatbed trailer 58. A worker or more than one worker can then secure the tarp 50 to the flatbed trailer 58 in a conventional manner to fully secure the cargo 56 beneath the tarp 50.

As the forklift moves along the flatbed trailer 58 during deployment of the tarp 50, the forklift 54 may slow down as it raises and lowers the roller body 32 to match the contours of the cargo 56. The momentum of the roller body 32 with the rolled up tarp 50 will cause it to continue to rotate, and deploy the tarp 50. This can lead to bunching or puckering of the tarp 50. However, the brake flap 60 provides resistance to the rotation of the wheel 38, and thereby slows the rotation of the roller body 32 in order to reduce this phenomenon.

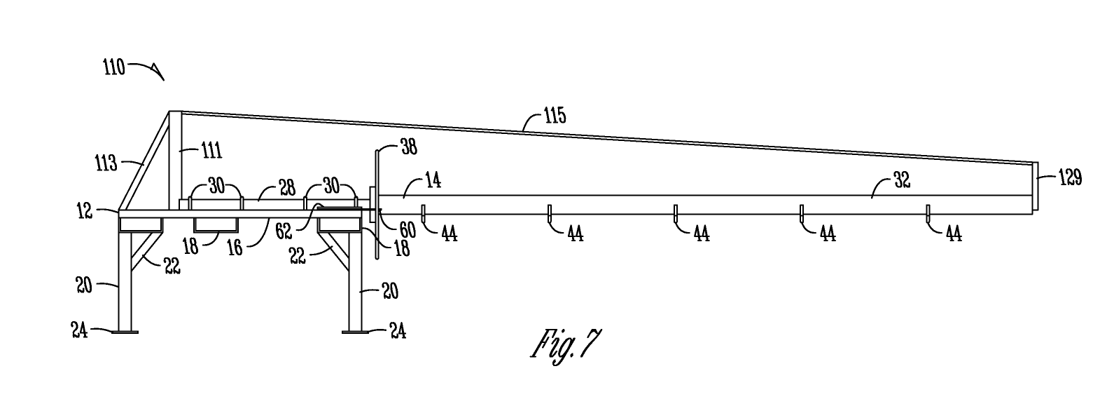

FIG. 7 shows an alternative embodiment for a tarp deploying apparatus 110. According to this alternative embodiment, the spindle 128 extends beyond the entire length of the roller body 32 and includes an upright portion 129 at its distal end. A riser 111 is provided that extends upwardly from the top plate 16. The riser 111 is braced by support 113. Additional supports (now shown) may also be provided to hold the riser in place. A wire 115, which may be a metal cable, spans between the top of riser 111 and upright portion 129 of spindle 128. The wire 115 serves to help support the weight of the spindle 128, roller body 32, and the tarp (not shown in FIG. 7). The arrangement of FIG. 7 has the advantage of being able to use lighter components for the spindle 128 as compared with the spindle 28 shown in the embodiment of the other figures. This may permit using a lighter, or even no counterbalance weight. However, it has the disadvantage of including the additional risers 111 structure and wire 115, which adds come expense, and more importantly, adds to the height of the tarp deploying apparatus 110, which in turn requires greater clearance space above and around the flatbed trailer during deployment of the tarp.

The foregoing drawings and description are of preferred examples for implementing the invention only. The scope of the invention should not be limited by this description. The scope of the invention is defined by the following claims. Those of skill in the art will be aware of additional features and modifications that can be made to these shown and described embodiments that will implement the invention and will fall within the scope of the claims.

What is claimed is:

1. A tarp deploying apparatus comprising:
a frame assembly, the frame assembly including attachment structure for connecting the frame assembly to a lifting device; and
a roller assembly extending generally laterally from the frame assembly, the roller assembly including a roller body, the roller body being adapted to have a tarp rolled upon it.

2. The tarp deploying apparatus of claim 1, comprising a plurality of hooks for engagement with openings in the tarp.

3. The tarp deploying apparatus of claim 2, wherein:
each of the hooks includes a body portion at a proximal end of the hook and a tarp retaining portion at a distal end of the hook that is generally transverse to the body portion;
when the roller body is oriented such that the tarp retaining portions extends generally upwardly, the hooks will retain a free end of a tarp such that it can be rolled on to the roller body by rotating the roller body in a first direction; and
when the roller body is oriented such that the tarp retaining portions of the hooks extend generally downwardly, the hooks will permit the free end of the tarp to fall off of the hooks as the roller body rotates in a second direction opposite from the first direction.

4. The tarp deploying apparatus of claim 1, wherein the roller assembly further comprises a spindle cantilever mounted to the frame assembly, the roller body being mounted to the spindle for rotation about the spindle.

5. The tarp deploying apparatus of claim 1, wherein the roller assembly further comprises a handle operably connected to the roller body whereby rotation of the handle causes corresponding rotation of the roller body.

6. The tarp deploying apparatus of claim 1 further comprising a brake member that resists rotation of the roller body.

7. The tarp deploying apparatus of claim 6, wherein the brake member is a resilient flap that is mounted on the frame assembly.

8. The tarp deploying apparatus of claim 7, wherein: the roller assembly further comprises a handle operably connected to the roller body for rotation with the roller body, the handle including a plurality of spokes; and the resilient flap extends from the frame assembly towards the handle such that a free end of the flap is in alignment with the plurality of spokes whereby rotation of the roller body causes the spokes to periodically contact the free end of the flap when the roller body rotates.

9. The tarp deploying apparatus of claim 1, further comprising a counterbalance weight on the frame assembly.

10. A method of deploying a tarp onto cargo loaded on a flatbed trailer, the method comprising:
attaching a tarp deploying apparatus to a forklift, the tarp deploying apparatus comprising a frame assembly and a roller assembly extending generally laterally from the frame assembly, the roller assembly including a roller body with a tarp rolled upon it;
positioning the forklift beside the flatbed trailer at a first end of the flatbed trailer with the roller body positioned generally above an upper surface of the cargo;
partially unrolling a portion of the tarp off of the roller body such that a first portion of the tarp is in contact with at least one of the cargo or the flatbed trailer; and
moving the forklift alongside the flatbed trailer toward a second end of the flatbed trailer with the roller body raised above the upper surface of the cargo whereby resistance caused by the first portion of the tarp in contact with the one of the cargo or the flatbed trailer causes the tarp to unroll off of the roller body onto the cargo.

11. The method of claim 10, further comprising: before the attaching step, loading a tarp on the roller body by engaging eyelets on the tarp to a plurality of hooks the roller body and rotating a handle operably connected to the roller body.

12. The method of claim 11, further comprising continuing moving the forklift alongside the flatbed trailer with the roller body raised above the upper surface of the cargo until the tarp falls off of the hooks.

13. The method of claim 10 further comprising raising and lowering the roller body with the forklift as the forklift is moving alongside the flatbed trailer to maintain the roller body at a desired distance above the upper surface of the cargo.

14. The method of claim 10, further comprising resisting free rotation of the roller body.

15. The method of claim 14, wherein a handle is provided in operable connection to the roller body for rotation with the roller body; a resilient flap extends laterally from the frame assembly towards the handle; and the resisting rotation of the roller body step is accomplished by the handle periodically contacting the resilient flap.

16. A tarp deploying apparatus comprising:
a frame assembly, the frame assembly including a top plate having an upper surface and a lower surface, the top plate further having first and second lateral edges spaced apart from and generally parallel to each other, the frame assembly further including attachment structures on the lower surface of the top plate and adapted for receiving tines from a forklift, and support structure for supporting the top plate above ground level;
a spindle mounted to the top surface, the spindle extending laterally beyond the first lateral edge of the top surface;
a roller body mounted to the spindle for free rotation about the spindle;
a plurality of hooks in alignment with each other on the roller body; and
a handle structure operably connected to the roller body for rotation with the roller body.

17. The tarp deploying apparatus of claim 16, wherein the spindle is an elongated shaft, the roller body is a cylindrical tube, and at least one set of ball bearings is provided between the spindle and the roller body.

18. The tarp deploying apparatus of claim 17, further comprising a brake for slowing rotation of the roller body around the spindle.

19. The tarp deploying apparatus of claim 18, wherein the brake comprises a resilient flap that periodically contacts the handle as the roller body rotates around the spindle.

20. The tarp deploying apparatus of claim 16, further comprising a counterbalance weight on the frame assembly near the second lateral edge of the top plate.
